(19) United States
(12) Patent Application Publication
(10) Pub. No.: US 2012/0145740 A1
(43) Pub. Date: Jun. 14, 2012

(54) Child-Resistant Pill Dispenser

(76) Inventor: Benjamin Chu, Morristown, NJ (US)

(21) Appl. No.: 12/967,565

(22) Filed: Dec. 14, 2010

(51) Int. Cl. B65D 83/04; B65G 59/00

(52) U.S. Cl. 221/277; 221/208

(57) ABSTRACT

Currently, pharmaceutical tablets are distributed in bottles that must be opened and closed; the pill-dispenser presented here aims to simplify the process for taking pills by releasing a tablet at the click of a button. Additional features of the dispenser are child-resistant capabilities, which may be considered a distinct claim, and use of click-pen mechanisms; furthermore, it can be used as a conventional open/close medication bottle, but doing so will disable its dispensing function. The purpose of this document is to lawfully protect future work on the design, development, and production of this device.

### INTRODUCTION

Pharmaceutical tablet prescriptions are usually distributed in the conventional translucent, orange plastic bottle with a child-resistant cap, where taking a pill requires removing the cap, a certain amount of sorting through the bottle, and finally replacing the cap. While this process is straightforward for many medication users, it can be further simplified with a pill-dispenser that incorporates existing “click-pen” systems. The device's main function is to dispense a tablet at the click of a button and the following are its key features:
1. It dispenses tablets one at a time, per click of a button by incorporating click-pen systems; furthermore, medication that has been dispensed may be re-inserted into the bottle by the same mechanism but with the bottle held upside-down
2. The dispenser's mode of operation is mechanical rather than electronic or automated
3. It can be used as a conventional open/close child-resistant medicine bottle if the user chooses, but doing so will disable the main dispensing mechanism

Though not essential to the device's main dispensing functionality, the next features are important for other reasons:
4. No prior arranging or aligning of tablets is necessary
5. To comply with existing packaging regulation, the clicking mechanism can be made child-resistant; incidentally, the child-resistant design submitted as part of the overall dispenser designs may be separately claimed
6. It is disposable or recycleable
7. It fits within and is an extension of the existing conventional prescription bottle
8. It is currently intended for personal/home use with prescription tablets, although extending usage to other domains or tablets is reasonably possible

It is expected that any medication user would find this device more convenient than the current open/close-bottle methods for taking medication because it reduces the time, number of steps, and processing needed to do so; people who have difficulty with the current methods, such as those with arthritis or can only use one hand for instance, would likely find this device especially useful.

The intent of this disclosure is to patent the proposed pill-dispenser along with eligible designs, descriptions, and claims submitted; in particular, the patent coverage would include any pill-dispenser that incorporates existing click-pen methods, is disposable, is part of and can function as the conventional pill bottle, and disables its dispensing mechanism once opened in that way. Acquiring a patent on this device would give the author more freedom to develop a device that has all (or a significant combination) of the listed key, patent-eligible features; one advantage, for example, would be time to explore design variations. This patent application also seeks to protect against inherent or unfair disadvantages that may be encountered during these endeavors, such as entering the field without prior resources or establishment.

### PRIOR ARTS

### Dispenser—

In July, 2010, a patent search for “dispenser AND (pill OR tablet)” and a patent application search for “dispenser AND pill” respectively yielded 3429 patents and 1640 applications, of which approximately 369 patents and 87 applications were reviewed further. During an update of the search conducted in December, 2010, six of 142 new patents and two of 81 new applications were reviewed further. These documents were checked for similarity in function or design. Many files shared design aspects or purposes as this proposed device, but none were considered to have the same design or all key functions. For example, many of the dispenser designs required a certain predetermined alignment of the pills prior to dispensing (U.S. Pat. Nos. 4,168,786, 7,523,841) or used electronic systems (U.S. Pat. Nos. 4,763,810, 4,962,491, 6,112,942), which are significant design differences from this proposed dispenser. Other files were designed for “blister-pack” tablets (20020108963, 20080142400, U.S. Pat. Nos. 4,574,954, 7,252,208), were simple compartments (U.S. Pat. Nos. 4,693,371, 7,240,795), or were meant for industrial use, which are fundamental differences in function. So far one reviewed patent, U.S. Pat. No. 7,216,776, mentions a dispenser that may be disposable, but it has a different design.

Some patented pill-dispenser designs had rotating components for aligning holes (U.S. Pat. No. 4,154,365), or “plunger”/clicking components (U.S. Pat. Nos. 3,968,902, 4,230,236) that are similar to those in the submitted designs, but they either had some differences as those described above (like prior alignment of pills) or employed a different mechanism of operation; these patents were considered most similar to this device because of similar components and intention to dispense a certain number of tablets. However, neither these patents nor any other so far claimed the functional abilities to be opened as a regular bottle or self-disablement; in addition, no related patent so far has incorporated click-pen systems into their design or fits within the existing open/close prescription bottle. These characteristics in function and design were decisive factors in going forward with the patenting process. Various individual design components such as the rotating wheel may be patent-eligible but were not further looked into; fortunately, these particular patents are expired, meaning that even if these design aspects are not novel or patentable, they still may be used.

### Child-Resistant Design—

A separate patent search for prior arts in child-resistant designs was made because this particular subsection of the dispenser design has potential relevance in other settings and thus may be distinctly claimed under this patent. A patent and application search for “child-resistant OR child-proof” in December, 2010, yielded 1662 patents and 1002 applications, of which about 240 files were further reviewed. The majority of reviewed files were related to ASTM Child-Resistant Product Types “Push Down While Turning” (U.S. Pat. Nos. 5,938,055, 7,527,159) or “Squeeze Two Points Simultaneously/Localized Squeeze Force While Turning” (U.S. Pat. Nos. 6,439,409, 5,927,526). Several of these files presented bi-modal designs where the child-resistance may be turned on or off (U.S. Pat. Nos. 6,618,909, 7,387,214), meaning this feature of the proposed design by itself is not new. The files considered most similar to the proposed design were applications 20010041315 and 20040256277 because they conceptually presented a blocking component in their respective cigarette-lighter and blister-pack-container designs; however, their blocking component differ from this design's in application, usage/operation, and lack of bi-modal capability. At a minimum, no files were found where a child is prevented specifically from pressing a button through the allotted hole and furthermore having bi-modal ability.

This independent review, made by the author, determined the proposition to be novel and patent-eligible because files were found to claim the ability to open as a conventional bottle or to disable itself upon opening, and the design approach in the proposed device appears non-trivial from prior patent designs even when functions were similar. Further (though weaker) confirmation for the dispenser's novelty include the author's observations of the current market as well as the assertion that the device was conceived and designed independently from any search for prior art. Additional confirmation for the novelty of the child-resistant design is how the U.S. Consumer Product Safety Commission does not list a similar design in their index of Child-Resistant Product Types (cpsc.gov/businfo/pppaguid/astmindex.html).

Possible limitations in this submitted patent search include how the USPTO electronic database does not have patents granted before 1976, as well as other queries that may not have been covered. The fact that patents prior to 1976 were not included in this search is deemed insignificant under the assumption that the post-1976 patents would have cited the relevant missing patents and claims from those patents could be inferred. Other possibly relevant searches that were not performed include those for click-pen methods and adding “tablet” to the “pill AND dispenser” application search; these queries were omitted due to either overlap or disparity in subject. With more time, performing these queries would produce a more thorough and ideal patent search; however, these additional queries are not expected to produce any consequential results and thus should make the submitted search sufficient.

In summary, the findings from the patent search are:
1. Many patents filed for pill- or tablet-dispensers had different functionalities; for example, U.S. Pat. No. 7,240,795 is a static compartment-box, U.S. Pat. No. 7,252,208 relates specifically to blister-pack dispensing, and U.S. Pat. No. 7,462,289 relates to liquid doses 2. Of the patents claiming devices that release one or more tablets, many had different design requirements such as a pre-alignment of pills or electronic mechanisms. A few of these patents had similar parts (like a rotating or clicking component) but had other significant differences, including those just mentioned. Overall, the proposed design was deemed patent-eligible because none of the reviewed patents incorporated click-pen systems. Certain individual design components may be patentable, including the child-resistant component.
3. In terms of functionality, one of the reviewed patents or applications claimed disposability, and none claimed an optional use of a conventional bottle or self-disabling capabilities; these functions should be clearly patent-eligible
4. The child-resistant button design appears unique since no reviewed patents claim an ability to prevent a button from being pressed, particularly with a side-tab that prevents it from fitting through the hole, and additionally having a non-child-resistant mode option
5. The conducted queries are considered sufficiently thorough for the scope of this patent application

### SUMMARY AND BRIEF DESCRIPTION

So far, two possible designs have been created to achieve the key goals and features described in the Introduction section. Both have the basic function where clicking a button will release a tablet, but the mechanisms vary.

### Design A —

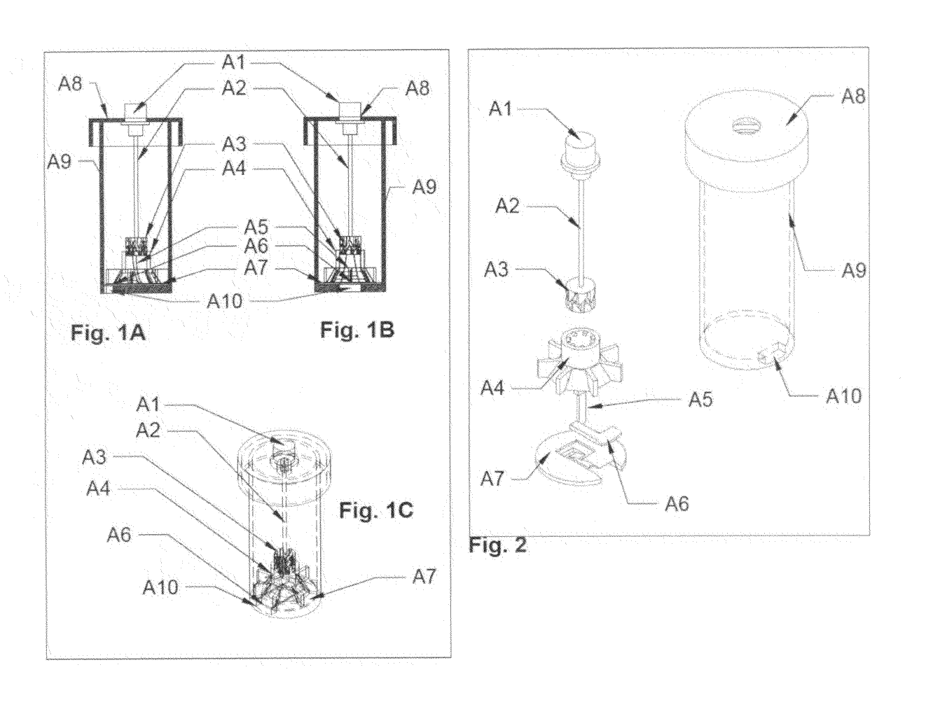

In the first design, clicking the tab button simultaneously rotates a wheel-like component and opens a sliding door, where the wheel slides a tablet over the open door. The main components found in this design are the button, a “wheel”, and an axel connected to the sliding door by a spring component. FIGS. 1-4 illustrate this design, where:

FIG. 1a-c respectively shows the front cross-sectional, side cross-sectional, and top-perspective views of the Design A dispenser as fully assembled

FIG. 2 is a piece-wise display of the components from the bottom-perspective view

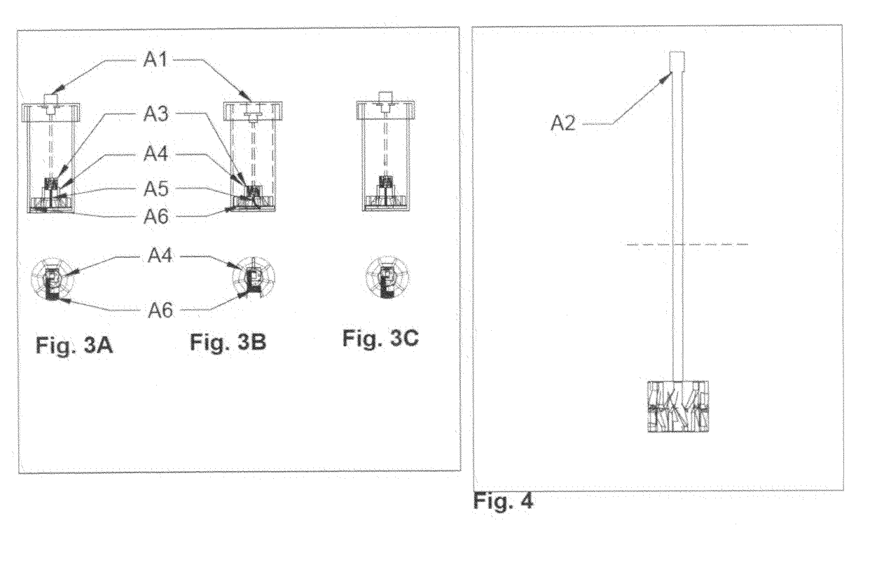

FIG. 3a-c demonstrates the intended actions of the dispenser, where:

FIG. 3a shows the inactive dispenser with button A1 unpressed

FIG. 3b shows A1 pressed, thus rotating wheel A4 a half-period and opening door A6

FIG. 3c shows A4 completing rotation and A6 closing

FIG. 4 shows the perforation in Design A so that it self-disables upon opening; perforation in Design B is similar

The wheel only moves in one direction and is meant to hold one pill in each compartment. A pill tablet may be re-inserted into the opening by first turning the bottle upside-down and then holding down the tab, much like how one can re-insert lead into a mechanical pencil. One may open the cap to use the dispenser as a conventional pill bottle; however, doing so will disable the dispensing function as claimed in the Introduction.

### Design B—

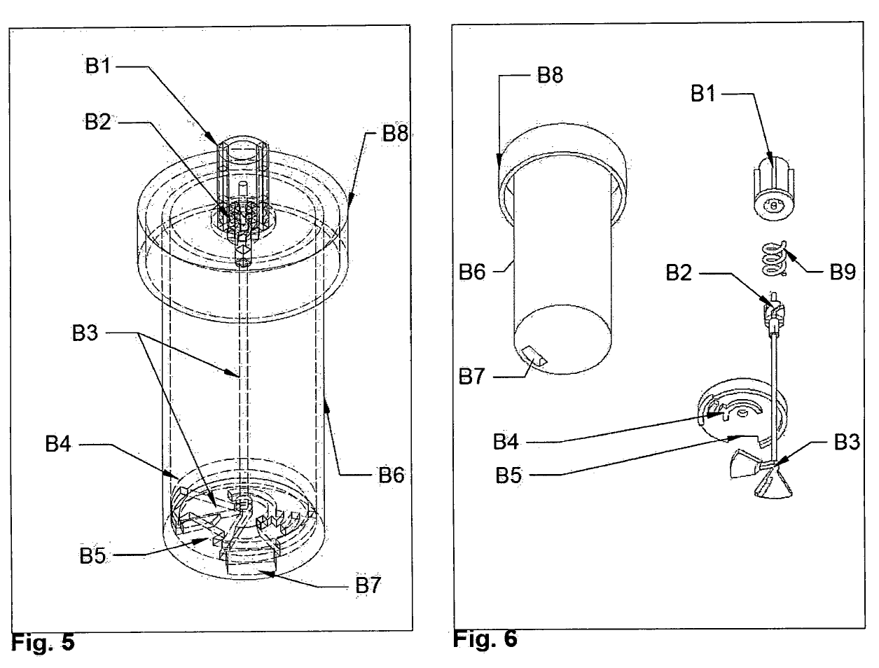

In the second design, clicking the button rotates the axel-compartment holding a pill so that the pill falls out the bottle opening, then rotates back into its original position; when at rest, the bottle opening is covered and the axel-compartment is open. The button, platform, and axel are the primary components in this design. FIGS. 5-7 depict this design, where:

FIG. 5 shows the top-perspective view of the Design B dispenser as fully assembled

FIG. 6a-b displays the individual parts from the bottom-perspective view

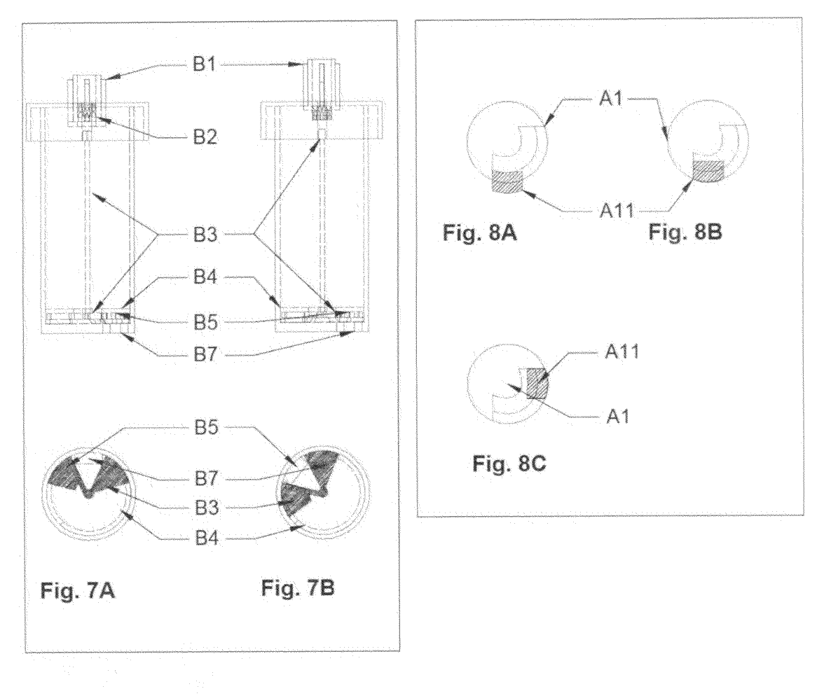

FIG. 7a-b shows the intended actions of the Design B dispenser, where:

FIG. 7a shows button B1 pressed to dispense pill over bottle-opening B7

FIG. 7b shows inactive formation to receive a pill from platform-opening B5

A pill may be re-inserted into the dispenser or the dispenser may be used as a conventional pill bottle in the same manner as Design A.

### Child-Resistance—

The intention of the child-resistant design is to require simultaneously pushing a side-tab inwards while pushing down the main dispensing button. One feature of this child-resistant design is its capability to be turned on or off, as opposed to many existing designs that are always “on” and needs disengaging every time.

FIG. 8a-c shows the current child-resistant design to be used with the two overall dispenser designs, where:

FIG. 8a shows neutral form, tab A11 blocks child from pressing button A1 down

FIG. 8b shows active form, A11 pushed in allows A1 to be pressed down

FIG. 8c shows A11 pushed in and rotated, turning child-resistance off

### DETAILED DESCRIPTION

### Dispenser —

FIGS. 1-4 illustrate Design A of the proposed pill-dispenser. For each of these figures, the index numbers refer to a design part as follows: the button (A1), axel (A2) with an attached click-pen component (A3), horizontal “wheel” (A4), spring component (A5) that connects click-pen/axel (A2/A3) with sliding door (A6), platform (A7) to guide the components, cap (A8), and bottle (A9) with opening (A10). Each division in wheel-component (A4) is meant to contain a single tablet and in this particular example, the wheel has seven “spokes”. FIGS. 1 and 2 depict these components in the assembled and unassembled form.

The intent of the design is for the user to press down on button (A1) and receive a pill out of the opening (A10). Pressing A1 will push axel (A2) and the attached, grooved “click-pen” component (A3) downwards by the same amount of displacement. The wheel-component (A4) will rotate as its hooks follow the grooves in the click-pen component (A3); at the same time, spring-component (A5) will be compressed and sliding door (A6) will open as it follows the guides in platform (A7) downwards and backwards. When button (A1) is fully pressed, wheel (A4) will have rotated halfway and sliding door (A6) will have fully opened, so that the pill tablet may drop out of opening (A11). Upon release of button (A1), spring (A5) returns to its relaxed state to close door (A6) and push the connected axel/tab components (A1-A3) upwards to its usual position; as components A1-A3 move upwards, the hooks of wheel-component (A4) will follow the grooves in (A3) so that it completes a full-period rotation as determined by the wheel-spokes. FIG. 3 illustrates these actions, where a full period in this particular case is 360/7 degrees.

The disable-upon-opening feature is achieved by the perforations located on the axel (A2) so that the axel breaks when pulled out, as shown in FIG. 4. The child-resistant feature, shown in FIG. 8, is described later in this section. While there are no “flaps” in the current design meant for better separation of pills, this feature could possibly improve the design and may be considered in future development. Also, the door-opening mechanism involving the spring (A5), door (A6), and platform (A7) is currently under revision.

FIGS. 5-7 illustrate Design B of the proposed pill-dispenser, where the indices in these figures refer to: the button (B1), click-pen component (B2), axel with a tablet-holding portion on the bottom (B3), platform (B4) with opening (B5) to separate an individual tablet to be released, bottle (B6) with opening (B7), cap (B8), and spring (B9). FIGS. 5 and 6 depict these components in the assembled and unassembled form. Tab-button (B1) has outer guides so that it cannot rotate within the cap (B8). Axel (B3) contains an area under the platform opening (B6) that holds a tablet, which is flanked by horizontal slabs to cover the holes (B5) and (B7) at the appropriate time.

As with Design A, the user presses down on button (B1) to receive a pill out of bottle-opening (B7). With this design, however, button (B1) has inner hooks that follow the grooves of click-pen component (B2) such that pressing down on B1 will rotate B2 along with its connected axel (B3). The bottom of axel (B3) houses a tablet, and rotating B3 will shift the tablet over bottle-opening (B7) while sliding a horizontal wall to cover the platform-opening (B5). Upon release of button (B1), the spring component (B9) will push B1 back to its neutral position, thus rotating the click-pen component (B2) and axel (B3) to its usual position. FIG. 7a-b shows the pill-dispenser when button (B 1) in the neutral/up and active/pushed-down configurations. The perforation in Design B is similar to that of Design A, and the child-resistant feature is the same.

Though not submitted in the current design, features meant for future consideration include different shapes, types, or curvatures of the platform and axel-compartment (beyond specifics based on pill-type). An obvious extension of both designs is adjusting them for different shapes and sizes of tablets and bottles.

### Child-Resistance—

FIG. 8 describes the general design for the child-resistant feature to be incorporated into the overall dispenser designs. The two components of this design are the main button (A1), which represents (A1) of FIG. 1-3 or (B1) of FIGS. 5-7, and side-tab (A11) that is perpendicularly embedded in A1. This child-resistant design requires simultaneously pressing inwards side-tab (A11) while pushing the entire button (A1) downwards; if side-tab (A11) is not pressed inwards, it will prevent the main button from fitting through the slot. A spring component on the inner face of side-tab (A11) normally keeps the side-tab pushed out. To turn the child-resistant mode off, side-tab (A11) should be pushed inwards and then slid tangentially to the labeled position where it is locked in the inward position according to the grooves in A1, as depicted in FIG. 8c. The detailed embodiment of the design is still under revision.

1. A disposable pill-dispenser using click-pen systems to release a single tablet upon clicking a button, can disable itself if used as a conventional pill bottle, is disposable, and fits within the existing pill bottle

2. One particular realization of claim #1, which uses a clicking/axel component, a horizontal wheel-like structure, and sliding door with spring as essential or unique parts;
the mechanism of this design is such that the pills are rotated horizontally over an opening.

3. A second particular realization of claim #1, which uses a different clicking/axel structure and a separating platform as its distinctive device parts; the mechanism of this design is that a pill isolated by the platform is rotated over an opening.

4. Child-resistant function and design submitted under claims #2 and #3 may be considered a distinct claim due to its potential general application

5. Improvements or variations on the design mentioned either specifically or generally in earlier sections of the document
Any concept, design, or production invalidly derived from this disclosure would be protected by . patent approval so that the author may fairly continue development of this device and benefit from the work.
